(19) United States
(12) Patent Application Publication
(10) Pub. No.: US 2006/0288014 A1
(43) Pub. Date: Dec. 21, 2006

(54) Method and software for mobile data collection having managed workflow

(76) Inventors: David Michael Edwards, Mississauga (CA); Igor Sandler, Vaughan (CA)

Correspondence Address: ANISSIMOFF & ASSOCIATES;RICHMOND NORTH OFFICE CENTRE, SUITE 201, 235 NORTH CENTRE RD., LONDON, ON, N5X 4E7, CA

(21) Appl. No.: 11/152,196

(22) Filed: Jun. 15, 2005

(51) Int. Cl. G06F 7/00

(52) U.S. Cl. 707/100

(57) ABSTRACT

A computerized method for collecting information on geo-spatially distributed assets. The method includes managed workflow so that work crews are automatically informed of the work that needs to be done and can report back to management when the work is completed. Mobile workers use a network-disconnected mobile computing device for data collection that includes a GPS receiver for use in generating a map showing the user's position in relation to the asset. An asset attribute database having a vertical database schema permits live-entry of the collected data without the need for confirmation, thereby speeding data entry and reducing the likelihood of data loss in the event of power failure, etc. The vertical database schema also permits data collection forms to be changed without updating the underlying database structure. The vertical database schema is converted to a relational database schema for management reporting purposes.

### FIELD OF THE INVENTION

The invention relates to the mobile collection and maintenance of enterprise data relating to a plurality of geo-spatially distributed assets in a manner that integrates workflow management for a plurality of potential users. More particularly, the invention relates to mobile GIS data collection by a plurality of disconnected users who periodically synchronize both the collected data and workflow information with network accessible databases.

### BACKGROUND OF THE INVENTION

In the management of geographically distributed assets it is desirable to periodically assess the condition of the assets and collect those condition assessments into a database that can then be used as a tool in planning repairs and capital expenditures. Condition assessment is normally performed by mobile workers equipped with some type of mobile computing device, such as a PDA or laptop, and a GIS database. The GIS database contains map information and asset location information and the mobile computing device is often equipped with a GPS receiver for use as an aid in navigation and asset identification. The data collection activities either take place in a continuously connected network environment (typically a wireless network) or in a disconnected environment using periodic data synchronization with a central server. Connected network environments are not suitable for data collection in remote areas where continuous network access is unavailable. Disconnected environments require sufficiently small file size that they mobile users can synchronize with a network accessible master database in a reasonable amount of time, even over dial-up modem connections, and typically have suffered from a lack of comprehensive data availability that limits the flexibility of individual users.

Since organizations that have a sufficient number of geographically distributed assets to warrant computerized data collection (for example, utility companies, government departments, railways, telecommunications companies, etc.) normally employ a large number of mobile field workers, it is necessary to manage the work being done in order to prevent double-collection of data on the same asset and to more efficiently plan data collection activities. In the past, the management of work flow has been conducted either manually (eg: by daily telephone or radio reporting on completion of assigned activities) or electronically using email or dedicated software for that purpose. It would be desirable to integrate work flow management with the data collection activities in order to simplify the overall process and to link these two different types of information; however, heretofore no such integrated data collection method currently exists.

U.S. Pat. No. 6,609,090, filed by Hickman, et al., discloses a computer based system and method for managing geographically distributed assets. The method employs laptop computers equipped with GPS receivers. Although work orders are automatically generated and issued to field technicians, there is no linkage between the collected asset data and the work orders, no tracking of the work orders through the system via work order databases, no electronic closing of work orders, etc. Furthermore, a QA/QC mirror database is used and every change to the master database must be approved by management personnel before being posted to the master database; this is labour intensive and throughput limiting for organizations in which a large number of field workers are collecting a large quantity of data.

In certain data collection applications, such as drive by or helicopter fly-over data collection, it is desirable to be able to rapidly enter data into the system to reduce the need for stopping or hovering while data is being entered about a particular asset. The rapid entry of data is often impeded in conventional systems by the need to confirm each change to the database before the change is saved, for example by clicking an “OK” button to save the change. It would be desirable to live-enter the change in a manner that immediately and automatically saves each change to the database. Live-entry of data is further advantageous in that it reduces the likelihood of data loss due to inadvertent power failure, system reset, etc. Although live-entry of data is known in certain database systems, for example point-of-sale purchase and inventory control systems, heretofore the need to ensure data integrity has prevented use of live-entry in conjunction with GIS data gathering.

To lessen the amount of data being transmitted during database synchronization and to speed data entry, it is desirable to reduce the file size of the data base. Databases employed in GIS data collection normally employ a relational database schema in order to group common types of assets and common asset attributes. In relational databases, like data types are grouped together by category in tables and the tables are inter-connected by pre-defined relationships. This categorization facilitates the generation of reports using the data, as assets of a given type may be selected for a given report. Examples of commercially available relational databases include Microsoft Access, Oracle, FoxPro, etc. are all relational databases. An alternative approach is to use a vertical database schema, wherein the records are not grouped and are instead provided sequentially in a common table or tables. Heretofore, vertical databases have not been employed in GIS applications due to the difficulties in report generation with un-grouped data. However, due to the number of relationships between categories, relational databases are inherently more storage space intensive than databases having a vertical database schema and, as a result, are slower to access and update.

In addition, as the data collection needs of the organization change the data collection forms also change; this is especially true in GIS data gathering applications. In relational database-based systems, the underlying database structure and the relationships between categories must be changed on each of the mobile computing devices, which is data intensive and requires expert attention that normally requires the mobile computing devices to be returned from the field for maintenance. It would be desirable to utilize a database schema that did not require updating when the data collection forms change. It would also be desirable to conduct updates to data collection forms during synchronization with the network in order to eliminate the downtime associated with returning the mobile computing devices from the field for updating.

Laptop computers are desirable in that they have sufficient processor speed and data storage capacity (eg: hard drive) that they can perform more complex tasks (such as map rendering) and can store a more complete database of map information or asset attribute information locally. However, laptop computers are typically not rugged enough or portable enough to be carried into the field and are often left within a vehicle where they can remain safe from harm and plugged-in to overcome battery life limitations. PDA's are more rugged, portable, and possess battery longevity; however, they suffer from small screens that are difficult to see in bright sunlight, have insufficient processor power and limited data storage capacity. For GIS applications, it is desirable to utilize a mobile computing device that overcomes some or all of these disadvantages.

It is further desirable that the graphical user interface (GUI) is laid out in an intuitive manner that takes best advantage of available screen real estate by providing ready access to the most commonly accessed data collection functions. U.S. Pat. No. 6,732,120, filed by Du, discloses a system and method for processing and display of geographical data. The method utilizes spatial indices (ie: grid co-ordinates) to group like objects and stores the grouped objects in a relational database; this is described as a space-based approach to data storage as opposed to the object-based approach most commonly employed in relational database systems. In addition to the previously described shortcomings of relational database systems, the space-based approach requires objects to be located by their spatial indices, which can become cumbersome when a large number of objects are located within a given index, as often occurs in asset management applications (eg: plurality of utility poles, transformers, switches, etc. all co-located within the same grid index).

The need therefore still exists for a mobile data collection method having integrated managed workflow, improved data entry speed and robustness in the event of failure, small database file size, etc.

### SUMMARY OF THE INVENTION

According to an aspect of the invention, there is provided a method of collecting geo-spatially referenced data using a mobile computing device having a global positioning satellite (GPS) data receiver, a data storage device, a central processing unit (CPU), a graphical display, and a network connection means, the method comprising: providing a network-accessible asset attribute database (AAD), the AAD containing attribute information relating to a plurality of geo-spatially distributed assets, each asset having a set of GPS co-ordinates; providing a network-accessible work request database (WRD), the WRD containing a plurality of work requests, each work request relating to a geo-spatially distributed asset in the AAD, the WRD including attribute information from the AAD for the asset; receiving work request information from the WRD via the network connection means and creating a local work request database (LWRD) containing the work request information; allowing a user to make changes to the attribute information in the LWRD in fulfillment of the work requests; and, periodically synchronizing the mobile computing device using the network connection means to update the WRD with both the work request and attribute information in the LWRD.

According to another aspect of the present invention, there is provided a method of managing geo-spatially referenced data comprising: providing a asset attribute database (AAD), the AAD containing attribute information relating to a plurality of geo-spatially distributed assets, each asset having a set of GPS co-ordinates; providing a work request database (WRD), the WRD containing a plurality of work requests, each work request relating to a geo-spatially distributed asset in the AAD, the WRD including attribute information from the AAD for the asset; periodically updating the attribute information in the WRD in fulfillment of the work requests; followed by, periodically updating the attribute information in the AAD with the attribute information in the WRD.

According to yet another aspect of the present invention, there is provided a computer software application for managing geo-spatially referenced data comprising: an asset attribute database (AAD), the AAD containing attribute information relating to a plurality of geo-spatially distributed assets, each asset having a set of GPS co-ordinates; and, a work request database (WRD), the WRD containing a plurality of work requests, each work request relating to a geo-spatially distributed asset in the AAD, the WRD including attribute information from the AAD for the asset.

Geo-spatially referenced data comprises any type of data referenced to a geographic location. A particular type of geo-spatially referenced data is data concerning the attributes of an asset located at a particular geographic location described by a set of GPS co-ordinates. The asset may comprise any type of physical object having attributes, particularly objects of an infrastructural nature such as municipal assets, utility company assets, telecommunications company assets, railway company assets, etc. Examples of suitable assets include but are not limited to the following: manholes, watermains, fire hydrants, utility poles, transformers, switches, utility meters, distribution boxes, railway crossing signals, railway switchgear, etc. Each of the geo-spatially distributed assets has a set of attributes. For example, the attributes of a utility pole could include its height, diameter, material of construction, etc. Attributes may also include photos of the condition of the asset and/or video or audio clips recording certain observations on the condition of the asset.

Connectivity between a given asset and other related assets is also a potential attribute. For example, a utility pole can carry conductors that connect the pole to other poles to form a transmission line. This permits utility poles along a certain transmission line to be grouped together for easy reference. In another example, a transformer may be connected to a switch and then connected to a load, such as a motor; this allows a virtual circuit diagram to be created depicting the physical assets involved in the circuit diagram along with their physical location. The ability to map connectivity between assets is advantageous in troubleshooting problems with physical assets by providing a straightforward way to track-down a particular defective asset in a defective circuit.

Asset attribute data is collected and updated by mobile workers who go to the actual location of the geo-spatially distributed asset. The mobile workers are typically equipped with a mobile computing device, such as a PDA, laptop, or tablet PC, that permits on-site data collection. A ruggedized tablet PC is preferred as it is more robust for field work as compared with a laptop and has a greater data storage capacity than a PDA, along with a larger screen that permits more intuitive data display. A pen-based user interface is preferred to simplify data entry and further ruggedize the mobile computing device by eliminating the need for a mouse, keyboard, etc. The mobile computing device is typically equipped with a GPS data receiver that allows the worker to record a set of GPS co-ordinates for a new asset and allows the user to differentiate between multiple assets of a similar type by that asset's unique geo-spatial identifier. The mobile computing device also is preferably equipped with a data storage device and a network connection means. The data storage device is preferably re-writable with a capacity in excess of 4 gigabytes (GB), preferably in excess of 40 GB. The data storage device may be a conventional hard disk drive, flash disk, or re-writable optical storage device. Preferably, the data storage device is a hard disk drive. The network connection means may utilize a wireless or a wired data connection. The network connection means may utilize a local area network (LAN), wide area network (WAN), or the internet. The network connection means may comprise an Ethernet card, a modem, a docking station, or a combination thereof. The network connection means may utilize the TCP/IP protocol.

Data collection normally occurs in a disconnected environment so that a user is required to periodically synchronize the locally collected data with a network accessible master database. The usual disadvantages of being disconnected from the master database, for example the unavailability of complete data for all assets in the database are mitigated in the present invention by local storage of the entire AAD or at least a relevant portion thereof. The relevant portion can be determined by geographic location of the mobile computing device and/or by the type of data collection being conducted by the user of that mobile computing device.

A work request relates to a particular asset or group of assets and defines an item of work to be performed in conjunction with that asset or assets. For example, a work request may comprise an inspection of an asset and updating its condition in the database, replacing an asset with a newer version of that asset in the same location and updating the serial number information, collecting GPS co-ordinate data and attribute information about a new asset, etc. Upon synchronization, each individual mobile user receives one or more work requests for a given work period (eg: day, week, month) from a network accessible work request database (WRD). The work requests received by the individual user are collected into a local work request database (LWRD). Alternatively, work requests may be generated locally, either by selecting an asset from the map or, if the asset is unavailable in the AAD, by creating a new asset. The locally generated work request is then entered into the LWRD and the asset is entered into the LAAD. This type of locally generated work request is particularly useful when conducting unspecified asset inspection, such as in a “patrol” inspection activity.

The LWRD is preferably stored locally on a data storage device of the mobile computing device to prevent inadvertent data loss due to power interruption, etc. The LWRD preferably has the same data structure as the WRD and may comprise the WRD in its entirety or a portion thereof that is relevant to the local user. In a preferred embodiment, individual users have access to work requests designated for other users within a given work crew or larger work unit, allowing a given user to aid another worker in completing work requests assigned to the crew. As individual work tasks are completed, the LWRD is updated to indicate the completion of the task, who completed the task, when it was completed, etc. Upon synchronization at the next available work period, the network accessible WRD is updating with the LWRD information. The WRD then contains up to date information on which work tasks have been completed and can be used to re-allocate un-completed tasks for completion in a different work period, by a different work crew or individual, etc.

The collection of information on the work itself rather than just the asset information is of particular use to management. Management can use the work request information to map out future work plans, report on the productivity of work crews or individual workers, etc. In addition, the collected attribute data is linked to the work request that was used to generate the data; this allows reviewers to resolve conflicts in collected attribute data that might arise due to differences in perception between individual data collectors, time of year or time of day in which the data was collected, etc. Since the work request information and the asset attribute information are typically of interest to different groups within management of a particular organization, it is advantageous to have two different databases that can be manipulated separately, yet retain a link that allows cross-referencing of the data in the databases.

The work request drives the collection of attribute data related to a particular geo-spatially distributed asset. The collected asset attribute data is stored in a network accessible asset attribute database (AAD). Upon synchronization, a mobile user receives asset attribute information from the AAD. The entire AAD or a portion thereof may be stored locally in a local asset attribute database (LAAD). The LAAD is preferably identical in structure to the AAD. The LAAD normally contains attribute information for only those assets that are pertinent to the local user; however, additional attribute information may be received from the AAD and stored on the data storage device for future use. By storing asset information locally, greater flexibility is provided to the field user to create a self-generated work request about any asset that he/she may encounter while in the field. In addition, individual users can be readily re-tasked to complete outstanding work requests. As asset attribute information in the AAD is updated through data collection by other mobile users, the LAAD is periodically updated via the LWRD following synchronization.

Either the WRD or the MD may be located on one or more database servers. The databases may be network accessible using, for example, the internet or a local area network. The MD and WRD are preferably similar in their data structure. The MD and the WRD preferably have a vertical database schema. As compared with a relational database, vertical database schemas are particularly effective in providing for rapid data entry, reduced file size, fast and efficient data access, etc. but are less effective in terms of grouping data in categories that allow for user-friendly manipulation and report generation. To mitigate this short coming, the present invention provides for the conversion of the vertical schema to a relational schema for use in off-line report generation by management personnel. Since report generation is not a concern in the field, this database specialization permits the “real time” advantages of a vertical schema to be realized by mobile workers, while still permitting management personnel to generate customized reports from the collected data.

The vertical schema preferably comprises only two main tables for each database. The first table, or object table, relates to item identification and the inter-relationships between items. The second table, or attribute table, contains attribute information for each item identified in the first table. Attribute data may include, dimensions, physical condition, materials of construction, rated load or capacity, colour, diagnostic measurements, photographs, video or audio clips relating to the asset or the mobile user's comments on the asset, etc. Video and audio clips are preferably provided as a link to a file stored in a suitable format in a location external to the database itself. A sequentially numbered object identifier may be used to index the individual records in the two tables. A parent object identifier may be provided to identify related items in the tables. For example, if the item in question is a transformer, the parent object may be the utility pole upon which the transformer is mounted. The parent object identifier may be used as an aid in mapping connectivity of assets.

In a preferred embodiment, the LWRD is stored on a data storage device of the mobile computing device and changes to the LWRD are live-entered immediately into the database without the need to confirm the change using, for example, an “OK” button. The vertical database schema facilitates live-entry by allowing rapid read/write access and smaller file size. Without this rapid read/write access, live data entry would appear slow and cumbersome to users, leading to frustration and data input errors. Live data entry is advantageous in that changes to the database cannot be inadvertently lost due to power failure, hardware error, etc. Live entry is also advantageous in that it permits data to be collected more quickly overall, which is of use in applications such as drive-by and helicopter based data collection where it is undesirable to stop in the vicinity of the asset for an extended period of time.

The LAAD and LWRD are periodically synchronized with the AAD and WRD using the network connection means. Upon synchronization, information from the LWRD is uploaded to the network and appended to the WRD. The AAD may be archived prior to being updated with new asset attribute information provided via the WRD. An automatic conflict checking procedure identifies any attribute data conflicts according to certain pre-determined rules and flags these conflicts for further review. For example, an upgrade in the condition of an asset as compared with a previous inspection (when no action has been taken to improve that asset's condition) signifies a discrepancy in the interpretation of condition and automatically generates a conflict for resolution by management. The work request information in the WRD may be used as an aid in resolving the conflict. Following the example given above, it may be known by management that the user who entered the upgraded condition routinely rates condition higher than the user who recorded the original condition information. The management personnel reviewing the conflict can decide whether to accept or reject the conflict-generating attribute change. Rejecting the change restores the original value of the attribute using information in the WRD. After uploading information from the LWRD, the latest data from the WRD is downloaded to the mobile user to ensure that the mobile user is kept current with both attribute and work request information. Application information, such as new database engines, new forms for data collection, new asset classes, etc. can also be downloaded upon synchronization.

In order to reduce the quantity of data be transmitted during synchronization and to take advantage of computing power within the mobile computing device, map data is preferably rendered from a geographic database stored on the data storage device. The alternative approach is to generate map data from image files (alternatively known as shape files), which are extremely data intensive and require an inordinate amount of time to download. In contrast, a geographic database is much more efficient in terms of data storage and requires less storage space overall, speeding synchronization. A map renderer is used to generate maps from the geographic database for display on the mobile computing device. Map rendering technology is known for use, for example, in internet based mapping services, such as MapQuest™. Since map rendering requires computational power, this approach is best utilized on mobile computing devices such as laptops or tablet PC's that have sufficient CPU resources and data storage capacity to generate the images. Flexibility is also improved in this approach, as each user has all map data stored locally in the event that he/she is required to collect data in a new geography, obviating the need for extensive downloading of map image files for that geography.

Due to the small database size provided by the vertical schema, it is possible to upload/download database updates in a reasonable period of time, even over a dial-up modem connection. The vertical database allows more rapid data collection for field users, which can be particularly advantageous in applications such as drive-by or helicopter-based data acquisition. In addition, when implemented using a mobile computing device having a data storage device, such as a tablet PC, a comprehensive database can be stored locally. This provides maximum flexibility for disconnected users while preventing data loss due to inadvertent errors or power failure. Using two separate databases to manage attribute data and work data provides maximum flexibility for management reporting, which is facilitated by the generation of customizable reports using a relational database conversion tool.

The invention may be utilized in GIS applications other than the collection of asset attribute information. For example, the invention may be utilized in agriculture, mining, forestry or any other application where it is useful to collect information on geo-spatially distributed things, for example crop type, location and condition; sub-terranean mineralogical deposit locations, types and quantities; location, types of trees and their condition in a forest, etc.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a schematic representation of the method steps executed on the mobile computing device;

FIG. 2 shows the various components of the application software residing on the mobile computing device;

FIG. 3 shows the component architecture of the application software residing on the mobile computing device;

FIG. 4 is a schematic representation of the method steps executed on the mobile computing device in conjunction with a network server;

FIG. 5 shows the various components of the application software residing on the network server;

FIG. 6 is a schematic representation of the method steps executed on the mobile computing device in conjunction with a network server showing management reporting functionality;

FIG. 7 is a flowchart showing application work flow;

FIGS. 8a and 8b diagrammatically depict the vertical database schema of the MD and WRD, respectively;

FIGS. 9a and 9b illustrate an example of the MD and WRD prior to initiation of a work request;

FIGS. 10a and 10b illustrate an example of the MD and WRD following initiation of a work request;

FIGS. 11a and 11b illustrate an example of the WRD and LWRD after data download upon synchronization;

FIGS. 12a and 12b illustrate an example of the LWRD and LAAD after updating the LMD with the LWRD following synchronization;

FIGS. 13a and 13b illustrate an example of the LWRD and LAAD during data collection;

FIGS. 14a and 14b illustrate an example of the LWRD and WRD after data upload upon synchronization;

FIGS. 15a and 15b illustrate an example of the WRD and AAD after updating the MD with the WRD following synchronization.

FIG. 16 shows a user interface for display on the mobile computing device with a Map tab selected;

FIG. 17 shows a user interface for display on the mobile computing device with a General tab selected.

### DESCRIPTION OF PREFERRED EMBODIMENTS

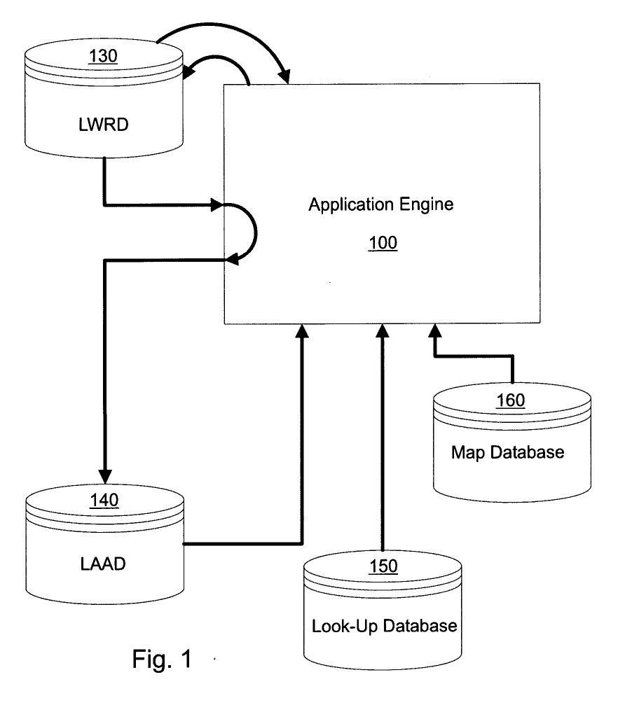

Referring to FIG. 1, the mobile computing device (preferably a tablet PC with a pen-based input device) has stored on its data storage device (preferably a hard disk drive) application software engine 100. On startup, the application engine 100 first synchronizes with the network, if available, to download work request and associated attribute information from the WRD and creates a locally-saved LWRD 130. The application engine 100 then updates or creates the LAAD 140 containing current attribute information relating to work requests stored in the LWRD 130. The application engine 100 includes code to produce a form-based graphical user interface on a visual display of the mobile computing device. The application engine 100 generates the forms by accessing a look-up database 150 that contains pre-defined categories for the user to choose from when entering data into the form (for example, pre-defined available condition states of the asset being assessed in a particular work request). These categories may be used to populate drop down lists on the form that are accessible by the user using the pen-based input device. The physical location of the asset is displayed on a map generated as part of the form. The application engine 100 produces the map by accessing geographic base data in map database 160 and using a map renderer to generate the map images for visual display. The map database 160 and look-up database 150 are stored on the mobile computing device and are periodically updated from corresponding databases on the server upon synchronization. As the user enters data into the forms, the LWRD 130 is updated upon completion of each form field. This immediately live-enters data into the LWRD and reduces the risk of data loss due to inadvertent power failure, system reset, etc. The LWRD 130 therefore contains all changes to attribute data in conjunction with the work request that generated the original need for data entry on that asset. As work requests are completed, the LAAD 140 is updated with the newly collected attribute information from the LWRD 130. This local updating of the LAAD can occur automatically upon completion of each work request or manually at any time in a batch process. The data from the LWRD 130 is periodically uploaded to the WRD using a network connection means.

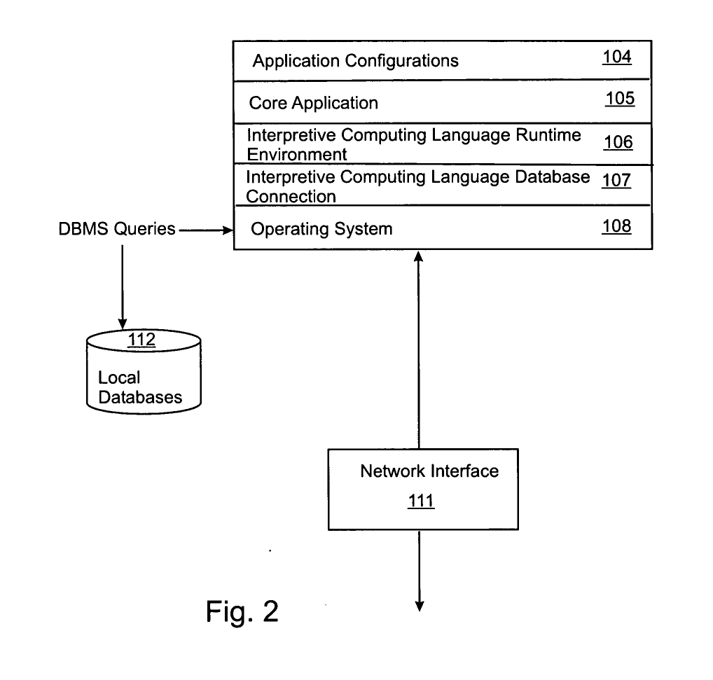

Referring now to FIG. 2, the various components that comprise the application engine 100 of the present invention are described. Forms generated using application configurations 104 produce the look and feel of the application. The application configurations 104 define high-level business logic, control and define the work flow, and additionally control any manipulation of the database management system (DBMS) that is required as a result of the configurations. The application configurations 104 are used to query the databases and perform operations on the databases such as insert, update and delete operations. These operations are embedded within the configurations and executed using a standard database query language such as the structured query language (SQL). The application configurations 104 can be implemented using any mark-up or “tag” language (proprietary or non-proprietary), such as HTML, XML, etc.. The core application 105 is the engine used to read and display the application configurations 104 and implements many of the lower level business rules and business logic. The core application 105 may be designed in one of many standard interpreted development languages such as .NET, Java, C++, etc. The core application 105 contains the mapping/GIS user interface and the data user interface and additionally is used to interpret a NMEA string provided by a GPS receiver, thus allowing the core application 105 to provide a real-time position on the map. An interpretive computing language runtime environment 106 may or may not be needed, depending upon whether the core application 105 is written in an interpretive computing language that is native to the computer operating system 108. The interpretive computing language runtime environment 106 is a Java runtime environment or any other virtual machine environment. A database connector component 107 is leveraged by the core application 105 to provide connectivity with local databases 112, such as the LWRD 130, LAAD 140, look-up database 150, mapping database 160, etc. The database connector component 107 comprises a suitable standard database connector such as JDBC, ODBC, etc. The computer operating system 108 may comprise Microsoft Windows 98/NT/2000/XP/XP Tablet Edition/CE, Pocket PC, Linux, Embedded Linux, Unix, Sun Solaris, Mac, Palm OS, etc. A pen-based computer operating system such as Microsoft Windows XP Tablet Edition, Microsoft Windows CE, Microsoft Pocket PC or Palm OS is the preferred operating system 108. Network interface driver 111 provides a connection between the pen-based computing device and the server (in particular, the database residing on the client computing device and the database residing on the server computing device) using a network connection means (not shown). The connection may be a wired connection or a wireless connection and may be provided using TCP/IP, RS-232 (Serial), USB, etc.

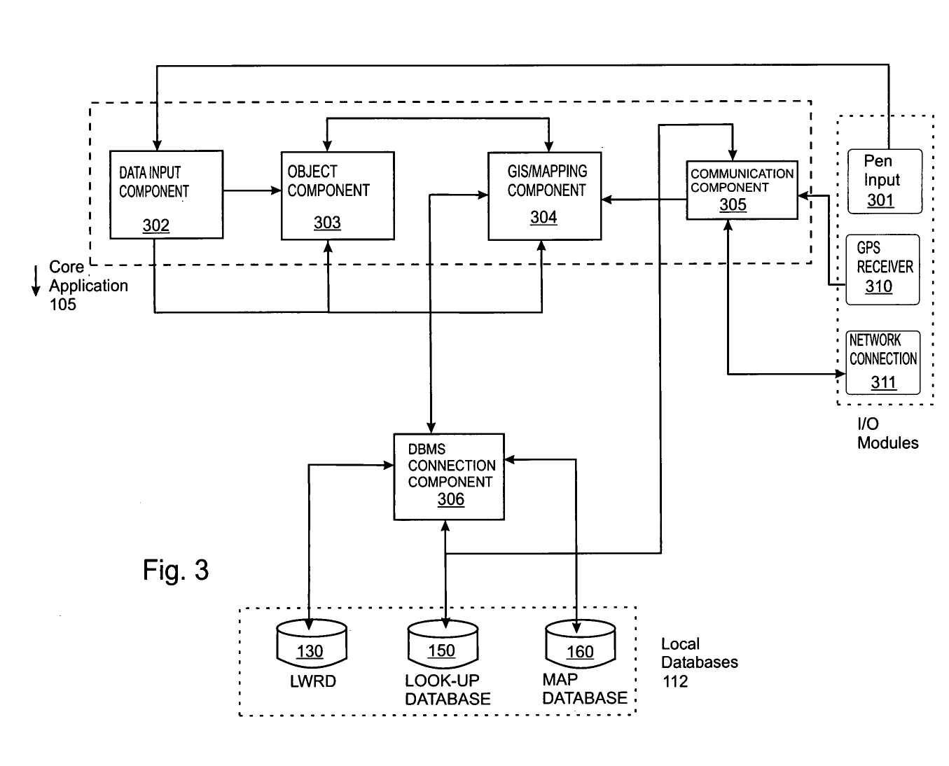

FIG. 3 shows the component architecture of the application engine 100 in greater detail. A user of the invention provides input to the system using a pen-based input device 301 via data input component 302. The data input component 302 interacts with the GIS/Mapping component 304 by providing the user the ability to select spatial features on the map, update the positions of spatial features and add new spatial features. The application configurations 104 are implemented using object component 303. The object component 303 receives data from the data input component 302 and provides visual feedback to the user through forms displayed on the mobile computing device. The object component 303 interacts with the database connector component 107 in two ways. Firstly, the database connector component 107 draws look-up values from the look-up database 150 and these values are displayed within the object component 303. Secondly, the user may create or update objects or their attributes through the data input component 302, which causes the object component 303 to immediately live enter the attribute information to the LWRD 130 through the database connector component 107. Every user action results in a database operation, thus preventing data loss due to power interruption, etc. The GIS/Mapping component 304 receives input from the communication component 305 in the form of a NMEA string provided by the GPS receiver 310, thus permitting display of the real-time map position. The GIS/Mapping component 304 interacts with the database connector component 107 in two ways. Firstly, spatial data that the database connector component 107 draws from the map database 160 is displayed by the GIS/Mapping component 304. Secondly, users may select features on the map which causes the database connector component 107 to query the map database 160 so that the GIS/Mapping component 304 can provide visual feedback to the user. In addition to receiving input from the GPS receiver 310, the communication component 305 also relays updates to/from the database connector component 107, by communicating with the network server via the network interface 111. The database connector component 107 functions as a broker between each of the various databases and other components. Preferably, the database connector component 107 leverages a spatially enabled database such as Oracle Spatial or PostGRE SQL. The map database 160 stores spatial data for display and manipulation within the GIS/Mapping component 304. Preferably, the spatial data is stored in a format suitable for map generation using a map renderer. The data may be stored in any spatial data format such as ESRI shape files, Intergraph, MapInfo, Autodesk, Bentley, etc. or any raster spatial data format such as geo-referenced TIFF (GEOTIFF), ASCII, etc. The map data includes base features such as roadways, waterways, topography, etc. and may also include business features such as customers, assets, employees, etc. Application configurations 104 or the core application 105 may access the map database 160 to modify the locations or attributes of geographical features. The look-up database 150 is a database table or a set of database tables within a DBMS used for the population of standard values or pre-set values that appear within the forms. Use of the look-up database is generally controlled by the application configurations 104, although it may be controlled by the core application 105 depending on the business logic required. A GPS data receiver 310 is a hardware device that provides a NMEA data string into the communication component 305 via a suitable connection. This NMEA signal is used by the GIS/Mapping component 304 to provide the user with their real-time position using the global positioning system.

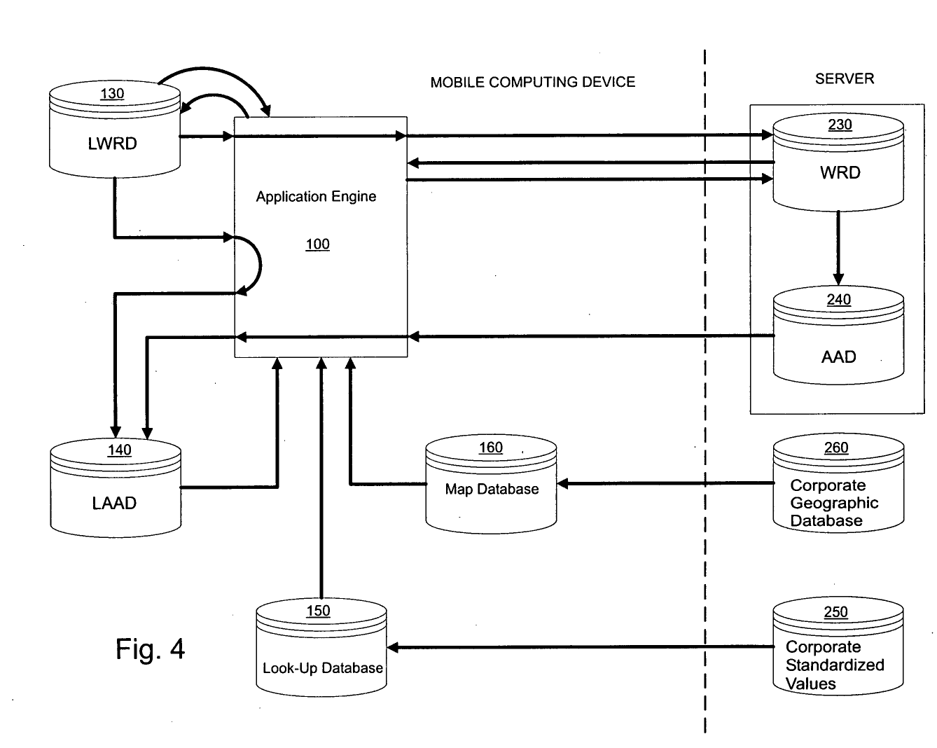

Referring to FIG. 4, data from the LWRD 130 is passed by the application engine 100 to the WRD 230 that resides on the server. The data from the LWRD 130 includes work request completion information including who completed the work request (or which work crew completed the work request), when it was completed, etc., along with information on any attributes that were updated or changed as part of the work request. The LWRD 130 is uploaded to the WRD 230, allowing the LWRD to be wiped clean of data. The AAD 240 is then updated with attribute data in the WRD 230 to ensure that the most up to date attribute information is available. Any new work requests relevant to the user are downloaded from the WRD 230 to the mobile computing device to populate the LWRD 130. The LAAD 140 may then be updated with the latest attribute information from the LWRD 130 to ensure that the mobile user is working with the most current asset attribute information. The AAD 240 may contain links to information other than attribute data (for example, photographic data or test results); this information preferably resides in a separate database to simplify overall database management and this separate database may be similarly updated upon synchronization. A corporate geographic database 260 is used to update the map database 160 residing on the mobile computing device. A corporate standardized values database 250 is used to update the look-up database 150 with new standard asset categories, asset groups (eg: transmission lines), condition types, etc. This ensures that all mobile users are choosing from the same list of input choices when creating new assets in the system or specifying asset attributes and prevents a proliferation of asset and attribute descriptions.

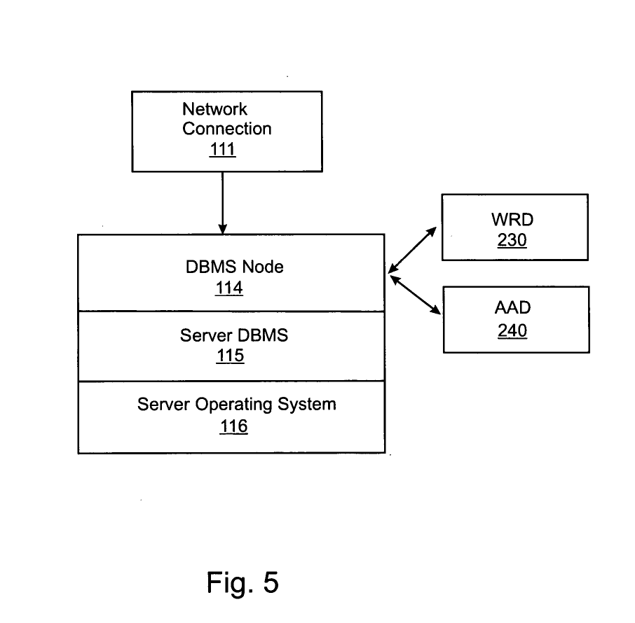

Referring to FIG. 5, the software residing on the network server that provides for receiving information from and sending information to the mobile computing device has the following components. The server leverages network connection 111 to communicate with the application engine 100 whenever the mobile computing device is connected to the server. The server then communicates with the WRD 230 and AAD 240 by opening a connection via DBMS node 114. The connection through DBMS node 114 can be opened through various techniques, such as: i) a direct database connection; ii) a shared pool connection; iii) a third party database connection method, such as a third-party application server. The DBMS node 114 leverages a server DBMS 115. The server DBMS 115 is a standard database that supports ANSI Standard SQL. The server operating system 116 supports multi-connected users in a highly parallel environment. The server operating system 116 may be Microsoft™ Windows® NT, Microsoft™ Windows® Server (any version), Unix (any version), LINUX, etc. The server may comprise one or more physical computers, depending upon the computing environment and decisions made at the time of implementation.

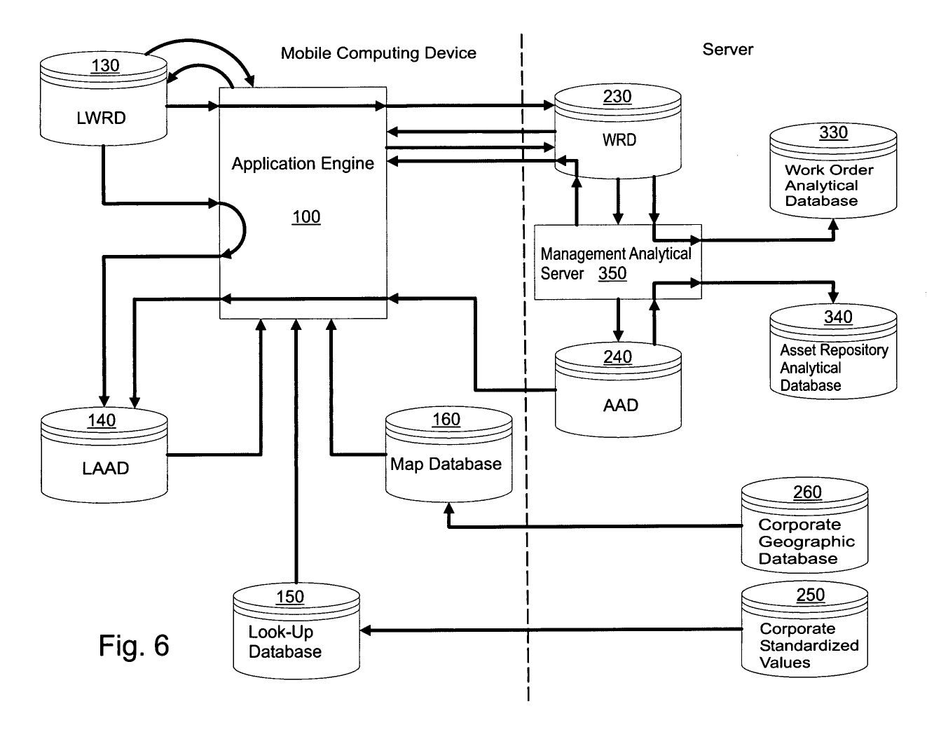

Referring to FIG. 6, in order to generate reports in a manner effective for management purposes, a management analytical server 350 converts the vertical database schema of the MD 240 and the WRD 230 into a relational database schema. The relational database schema allows information to be grouped and manipulated in categories, facilitating the generation of custom reports to suit any particular management purpose. The management analytical server 350 converts the WRD 230 (vertical) into a work order analytical database 330 (relational) and converts the MD 240 (vertical) into an asset analytical database 340 (relational). The management analytical server 350 then draws upon the relational databases 330 and 340 in generating customized management reports.

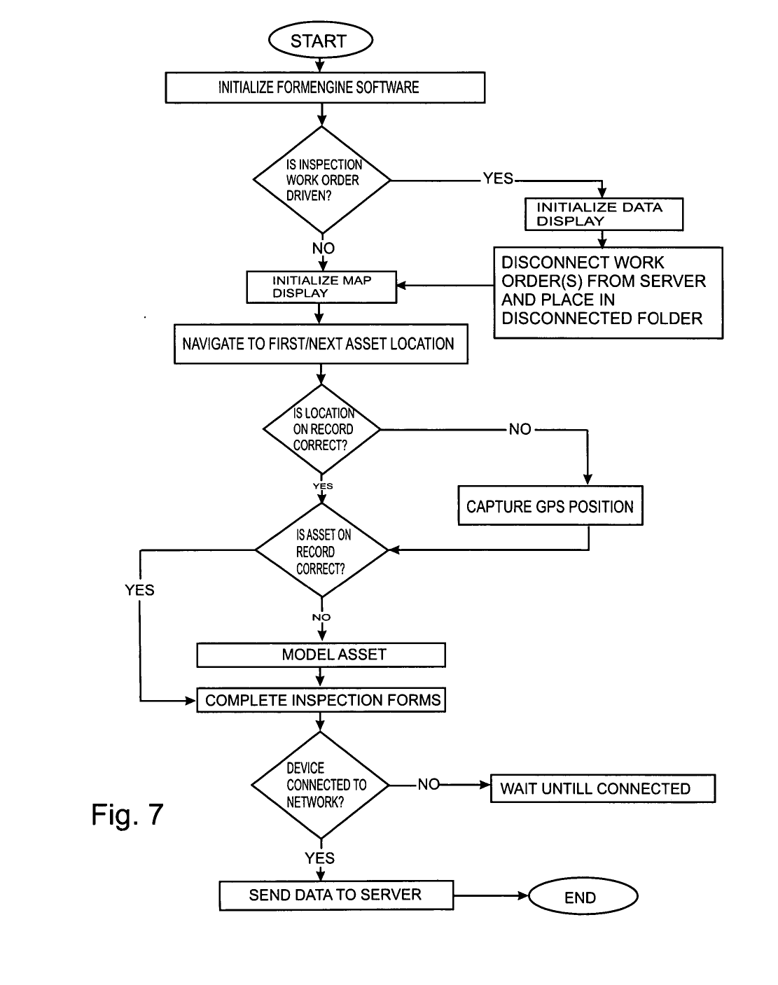

Referring to FIG. 7, when the application engine is initialized, the first step in the process is to determine whether the current data gathering session is work order driven. If it is work order driven, then the software will attempt to connect to the network server to: i) retrieve updates (program and base data); and, ii) display the server side folders that hold the open work orders. Once these steps have been completed, the mobile computing device disconnects from the network and the application engine generates the forms and the map for display. If the session is not work order driven, then the mobile computing device still attempts to connect, but only retrieves updates to the application engine and base data, if available. The user is then permitted to create work requests and populate the LWRD with data from the LAAD as needed. Once the mobile computing device is disconnected from the network it operates in disconnected mode. The forms and map are displayed on the visual display of the mobile computing device and assist the user both in identifying the asset and in navigating to the asset location. If the asset is in the database and its location is correct, then the user is permitted to update any attribute data as required on the form. If the asset is not in the database or if the location of the asset is incorrect or unknown then the application engine captures a set of GPS co-ordinates corresponding to the location of the asset and optionally generates a new asset entry form for collection of asset attributes by the user. If the asset attributes are incorrect or incomplete, then the user enters or updates the attribute information by modeling the asset. The inspection form is then completed and the work order can be closed. At that time, the LAAD 140 can be automatically or manually updated with the new attribute data. The process is then repeated for the next work order, whether the work order is self-generated or previously retrieved from the WRD. When the mobile computing device is connected to the network, the data in the LWRD is synchronized with the WRD as previously described.

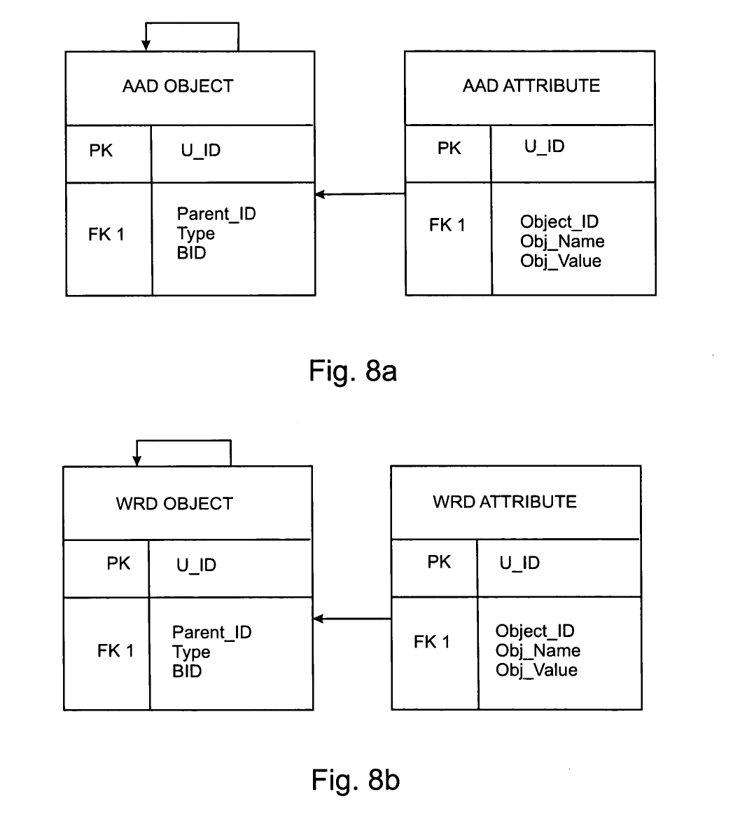

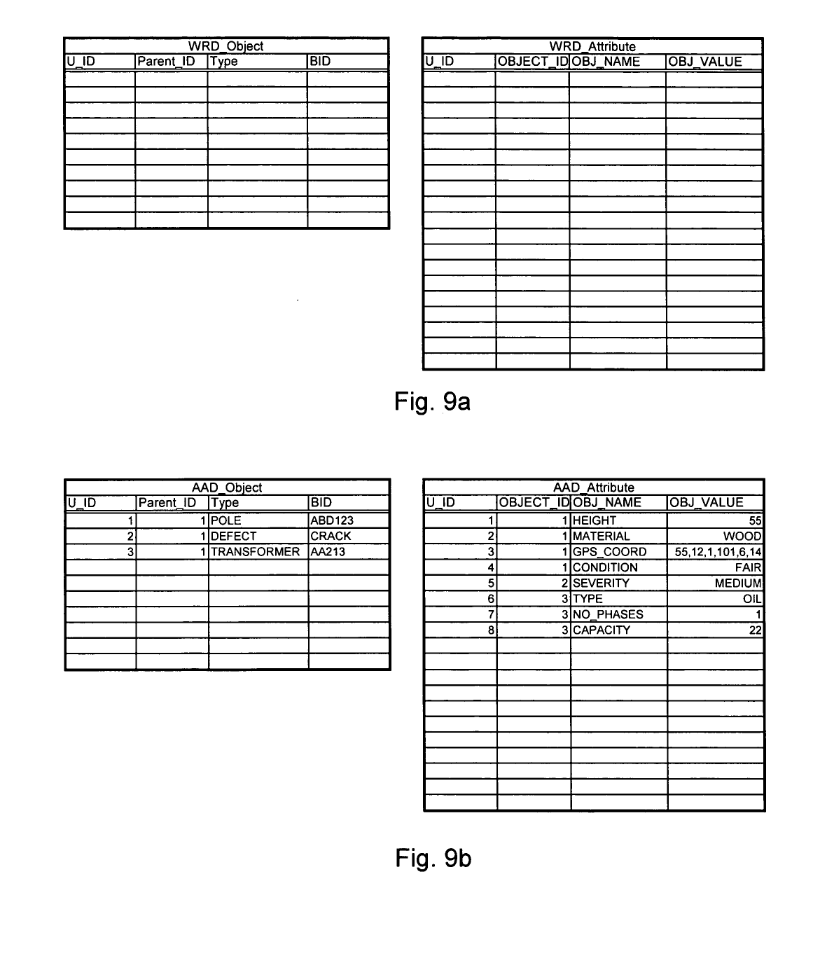

Referring to FIGS. 8a and 8b, the data schema of the AAD and WRD, respectively, are depicted diagrammatically. Each database has two primary tables, an object table and an attribute table. The WRD has an identical database schema to the MD. The LAAD and the LWRD have identical schemas to the AAD and WRD, respectively. The relationships between fields in the tables and how the values in those fields inter-relate with individual database records will be more fully explained with reference to FIGS. 9 to 11.

FIGS. 9a and 9b depict the WRD and MD, respectively, after the system is freshly installed and asset attributes have been entered, but no work requests have been initiated. The WRD in FIG. 9a has no entries in either the object or attribute tables. The MD in FIG. 9b has an Object Table illustrated with a an object of Type POLE in row one. The U_ID is a sequentially numbered field used as a reference for the table row occupied by a particular object in the object table. The Parent_ID field lists the U_ID of the parent object to which the object in a particular row of the table is immediately related. For example, in FIG. 9b, row two contains an object of Type DEFECT related to the object of Type POLE in row one, as indicated by the Parent_ID of 1. In other words, the defect “belongs” to the pole having a U_ID of 1. Similarly, the object of Type TRANSFORMER in row 3 has a Parent_ID of 1, indicating that the transformer is mounted on or co-located with the utility pole having a U_ID of 1. The BID field contains a business identifier used to specifically indicate the individual object being described on a given row. The object of Type POLE in row 1 has a BID corresponding to its serial number, as does the object of Type TRANSFORMER in row 3. The object of Type DEFECT has a BID of CRACK to more particularly indicate the type of defect being attributed to the utility pole in row 1.

Each row of the Attribute Table depicted in FIG. 9b corresponds to an attribute of a particular object in the Object Table. Each row of the Attribute Table contains a sequentially numbered U_ID for use in cross referencing individual records in the table. The Object_ID field relates to the U_ID of a particular object in the Object Table. The Obj_Name field describes the particular attribute and the Obj_Value field gives an alpha-numeric value to the attribute. For example, rows 1 to 4 of the Attribute Table have an Object_ID of 1 and relate to the object of Type POLE having a U_ID of 1 in the Object Table. The pole has four attributes, described in the Obj_Name field as HEIGHT, MATERIAL, GPS_COORD, and CONDITION. Each of the attributes has a value as indicated in the Obj_Value field. Similarly, row 5 of the Attribute Table has an Object_ID of 2 and relates to the item having a U_ID of 2 in the Object Table. The attribute in row 5 of the Attribute Table therefore describes the DEFECT: CRACK from row 2 of the Object Table and has a SEVERITY with a value of MEDIUM as described in the Obj_Name and Obj_Value fields, respectively. Similarly, rows 6 to 8 of the Attribute Table contain attributes of the object TRANSFORMER described in row 3 of the Object Table.

From the foregoing description, it can be seen that individual records in the two tables are inter-related by the Parent_ID and Object_ID fields, creating an efficient data structure which utilizes a small number of tables. By comparison, a relational database would contain a plurality of tables, each table grouping together similar objects and attributes, and the tables would be interrelated to associate the attributes with the objects. For example, in a relational database there would be separate tables for objects of type POLE, DEFECT and TRANSFORMER, and those tables would be related to tables for the various attributes in the Attribute Table. In total, there would be 11 inter-related tables in a relational database versus 2 tables in the present invention. The advantage of the data schema of the present invention is in increased data access speed, which is useful in drive-by and fly-over data collection, and in reduced overall database file size, which is useful when synchronizing over a dial-up or wireless network connection. To achieve the advantages of a relational database for report generation, the vertical schema can be converted to a relational database schema. After conversion, reports can be generated grouping like objects having like attributes. For example, a report could be generated listing all POLES having CONDITION: FAIR after conversion to a relational database schema. The system therefore permits database optimization for both real-time data collection and subsequent server-side report generation and analysis.

The vertical data schema is particularly advantageous when making changes to the data collection forms. Since the Type field can include any object as defined in the Corporate Standardized Values database, new objects can be added and new forms created using those objects with no effect on the underlying database schema. In a relational database, the addition of a new object type necessitates the creation of a new table for all instances of that object type and the new table must be inter-related with the attribute tables, etc. This of necessity changes the underlying schema of the database and requires an extensive software upgrade, normally performed by trained personnel at a head office location and requiring significant down-time for field personnel from data collection activities. The vertical schema having only two generic data tables is therefore particularly advantageous in GIS data collection, where data collection forms change frequently.

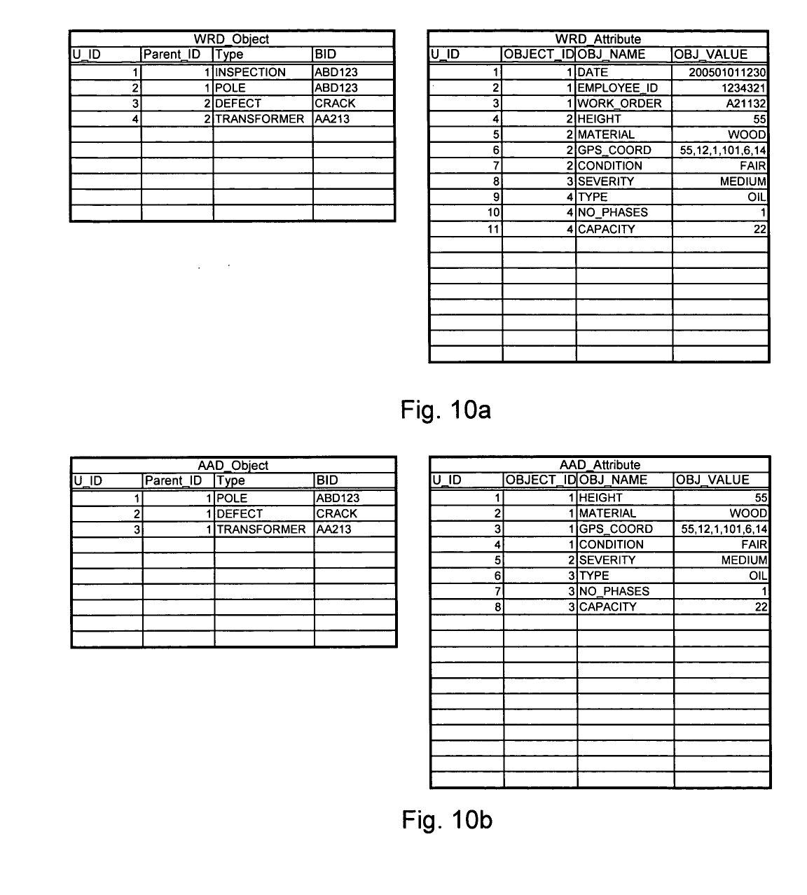

FIGS. 10a and 10b show the WRD and AAD, respectively, after the generation of the first work request. The work request is listed in row 1 of the WRD Object Table and has Type INSPECTION and a BID identifying the individual work request. The asset being inspected is the utility pole ABD123 from row 1 of the AAD Object Table. The Parent_ID of the pole in row 2 of the WWRD Object Table is the U_ID of the object INSPECTION in row 1 or the WRD Object Table. The Parent_ID field therefore continues to relate objects within the Object Table. The DEFECT and TRANSFORMER objects on rows 3 and 4 of the WRD Object Table have Parent_ID's of 2, indicating that they “belong” to the pole having a U_ID of 2 in the WRD Object Table. Similarly, the WRD Attribute Table contains attributes for each object in the WRD Object Table. The object INSPECTION has attributes described on rows 1 to 3 of the WRD Attribute Table, as indicated by the Object_ID of 1 for those rows corresponding to the U_ID of 1 for the object INSPECTION in the Object Table. The attributes of the remaining objects described in the WRD Object Table are provided in the WRD Attribute Table and have Object_ID's relating to the U_ID's of their respective objects in the WRD Object Table.

It can be seen that the WRD relates the work being done with the assets on which the work is being performed, all in one database. Each work request relates to a particular asset or series of objects from the AAD Object Table and those objects are copied into the WRD Object Table and cross-referenced with the work request through the Parent_ID field. The attributes in the Attribute Table continue to be referenced to the objects in the Object Table through the Object_ID field. In this manner, all of the object and attribute information from the AAD is present in the WRD for the assets that are the subject of each work request.

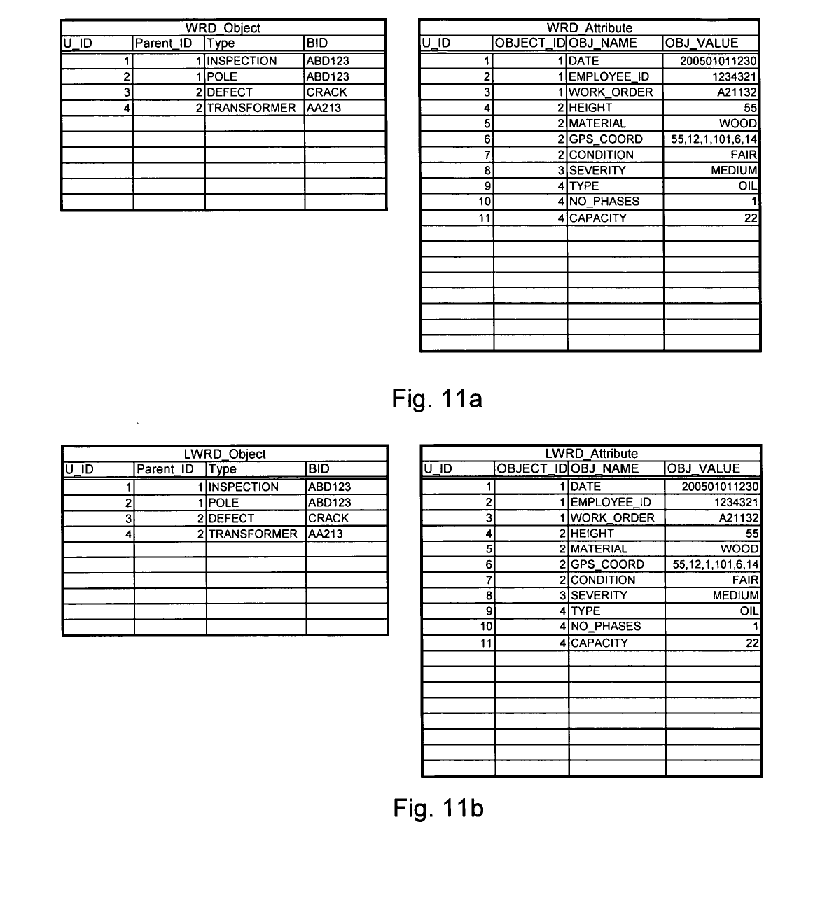

FIGS. 11a and 11b show how the LWRD is created upon synchronization of the mobile computing device with the network accessible databases. The work requests relating to the particular field user are downloaded to his/her mobile computing device and an LWRD is created containing those work requests. The LWRD is identical in structure to the WRD, but contains only the sub-set of WRD data relating to the particular field user or field workgroup to which the user belongs.

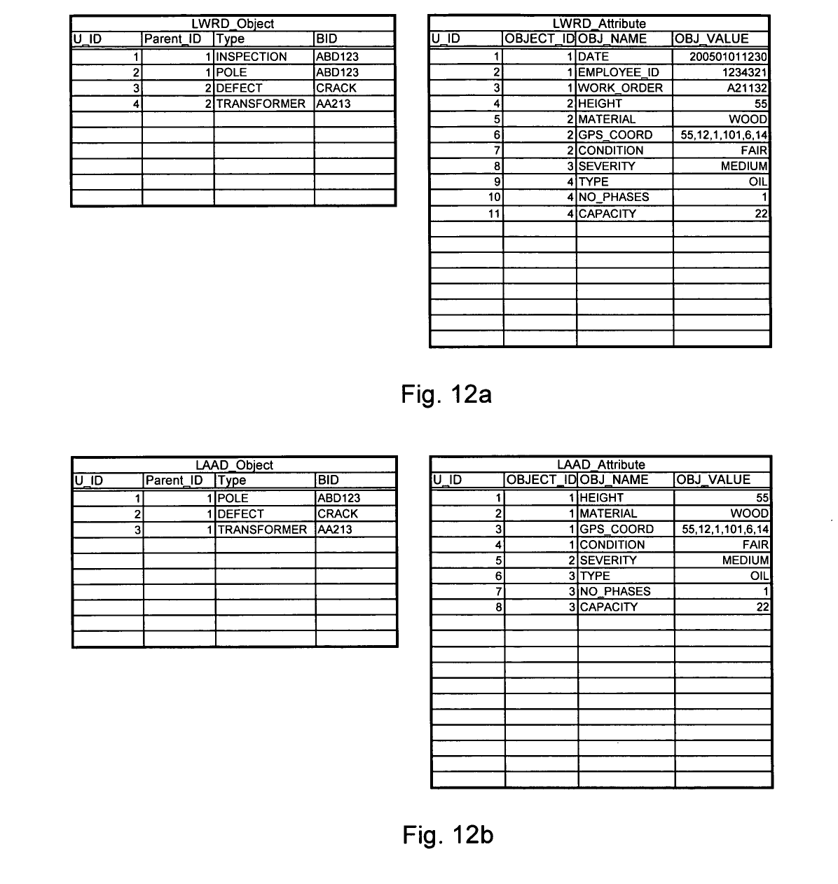

FIGS. 12a and 12b show how the LAAD is generated from the LWRD after synchronization. The LAAD is created using the latest object and attribute information from the LWRD. In this manner, the LAAD remains up-to-date with only the most current information. Both the LWRD and LAAD are stored on a local data storage device drive of the mobile computing device to reduce the likelihood of inadvertent data loss due to power interruption, etc.

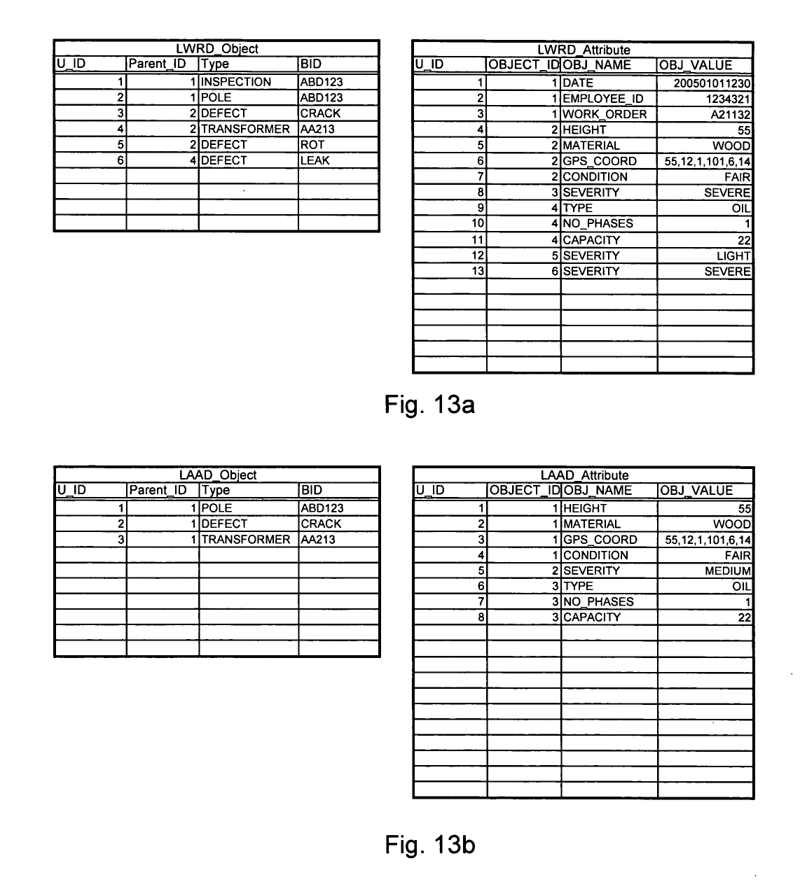

FIGS. 13a and 13b show the LWRD and LAAD during data collection activities in fulfillment of the work requests in the LWRD. Two additional objects have been added to the LWRD, as shown on rows 5 and 6 of the Object Table. The objects are of Type DEFECT and have a BID of ROT and LEAK, respectively. The attributes of those objects are indicated in rows 12 and 13 of the LWRD Attribute Table, respectively. Similarly, the CONDITION of the object DEFECT in row 3 of the LWRD Object Table has been downgraded from FAIR to SEVERE, as indicated by the Obj_value on row 8 of the LWRD Attribute Table. When the inspection is completed and the work request is closed, the LAAD can be updated with the latest object and attribute values from the LWRD.

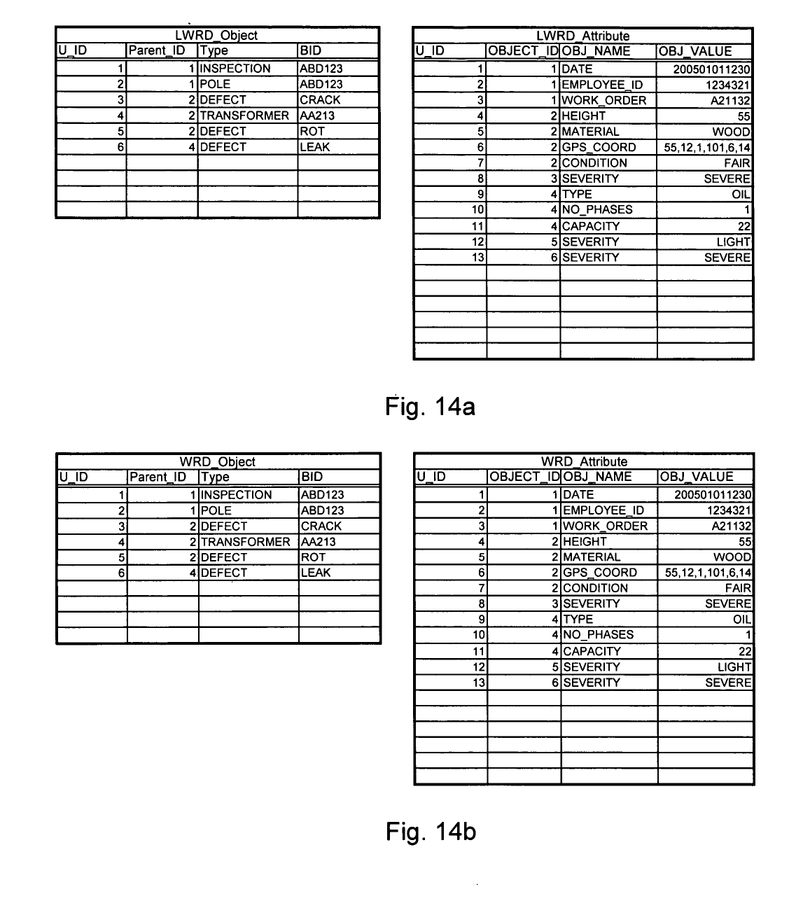

Referring to FIGS. 14a and 14b, the LWRD and WRD are shown, respectively, during the next synchronization of the mobile user with the network. The Object and Attribute Tables of the LWRD are then appended to the WRD. The WRD therefore grows each time a synchronization occurs and contains a work history of all work performed and the attribute values before and after completion of the work. In the event that a data collision or data conflict occurs (for example, the CONDITION of a DEFECT improves upon a subsequent inspection when no corrective action has been taken for that defect), then the work history of the WRD can be used to determine whether or not to re-instate the old attribute. The detection of data collisions and conflicts may be conducted in “near real-time” or in a batch process (typically overnight) according to certain pre-established business rules. The work history may be used by management to determine which field worker collected the conflicting data and, knowing certain factors about the field worker, to determine whether or not to accept the conflicting data. For example, a particular field worker may be known to assess a six inch crack as SEVERE, whereas another worker might assess the same crack as MODERATE. In that case, management personnel can decide which assessment to use. The linking of work information with asset attribute information is therefore particularly useful in the resolution of data conflicts.

After synchronization, the data in the LWRD is erased and the LWRD is ready to accept a new set of work requests from the WRD. After the work requests are downloaded a new LWRD is created, as previously described with reference to FIGS. 11a and 11b.

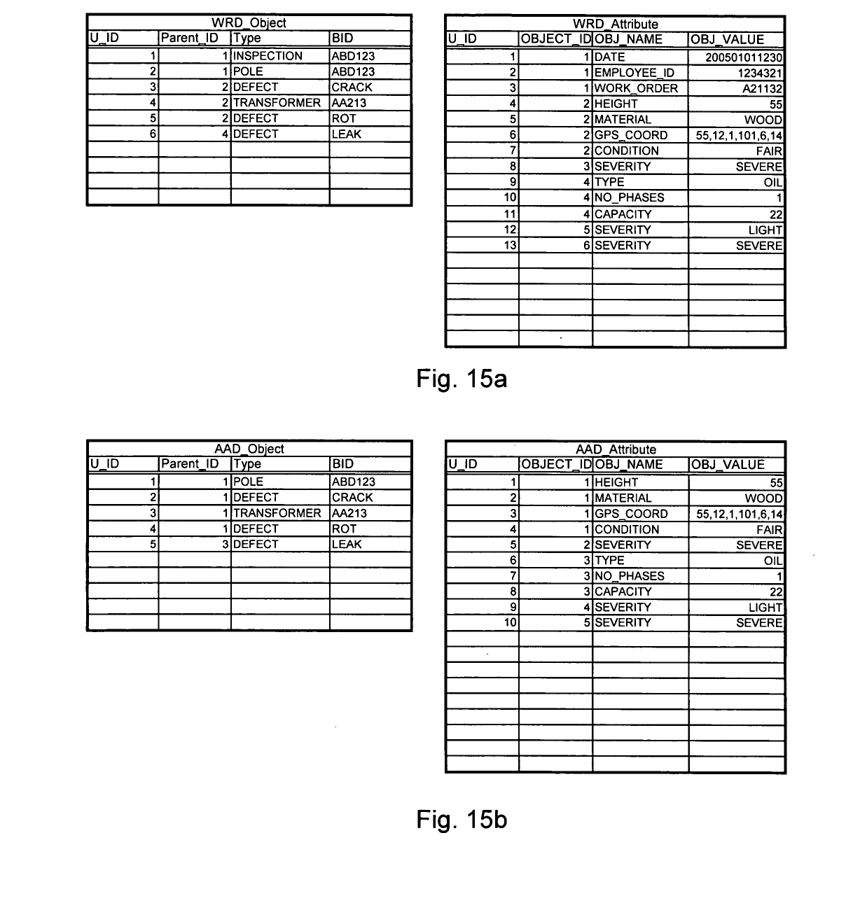

Referring to FIGS. 15a and 15b, the AAD is updated periodically with the newly collected object and attribute data from the WRD. The objects from rows 5 and 6 of the WRD Object Table are copied to rows 4 and 5 of the AAD Object Table, with their Parent_ID's changed to 1 and 3, respectively, so that they continue to relate to the objects POLE and TRANSFORMER in the AAD Object Table. The attributes of those objects, from rows 12 and 13 of the WRD Attribute Table, are copied to rows 9 and 10 of the AAD Attribute Table with their Object_ID's changed to 4 and 5, respectively, to correspond with the U_ID's of the objects in the Object Table. The Obj-Value of the attribute in row 5 of the AAD Attribute Table is over-written with the latest SEVERITY observation. By over-writing and appending data to the existing table, the AAD remains as a single up-to-date source of attribute information for reporting purposes etc. The AAD does not need to be archived prior to updating, as the history of the attribute data is maintained in conjunction with work request information in the WRD. This obviates the need for data intensive copy operations when updating asset attribute information in the AAD.

The foregoing describes the series of database operations in a work request driven data collection session. In a “patrol” type data collection session using self-generated work requests, a single “patrol” work request is generated in the WRD to which is linked object and attribute information for any known assets expected to be encountered during the patrol. These are used to populate the LAAD. When new assets or objects not present in the LWRD and LAAD are discovered, a local work request is generated and the new assets or objects are added to the LWRD. Upon completion of the locally generated work request, the LAAD is updated. During synchronization, the locally generated work requests and related asset or object information are uploaded to the WRD from the LWRD and the new attribute information is subsequently added to the AAD in the usual manner.

In entering data into the databases, the field user is only permitted to select Type and Obj_Name values from the Look-up Database. If no applicable values are present, then new values may be locally created and added to the Look-up Database. Values for the BID and Obj-Value fields may be selected from the Look-up Database or free-form entered, dependent on the corresponding Type and Obj_Name. The local Look-up Database is periodically synchronized with the Corporate Standardized Values database. Upon synchronization, the Corporate Geographic Database and any new data collection forms are also downloaded to the mobile computing device.

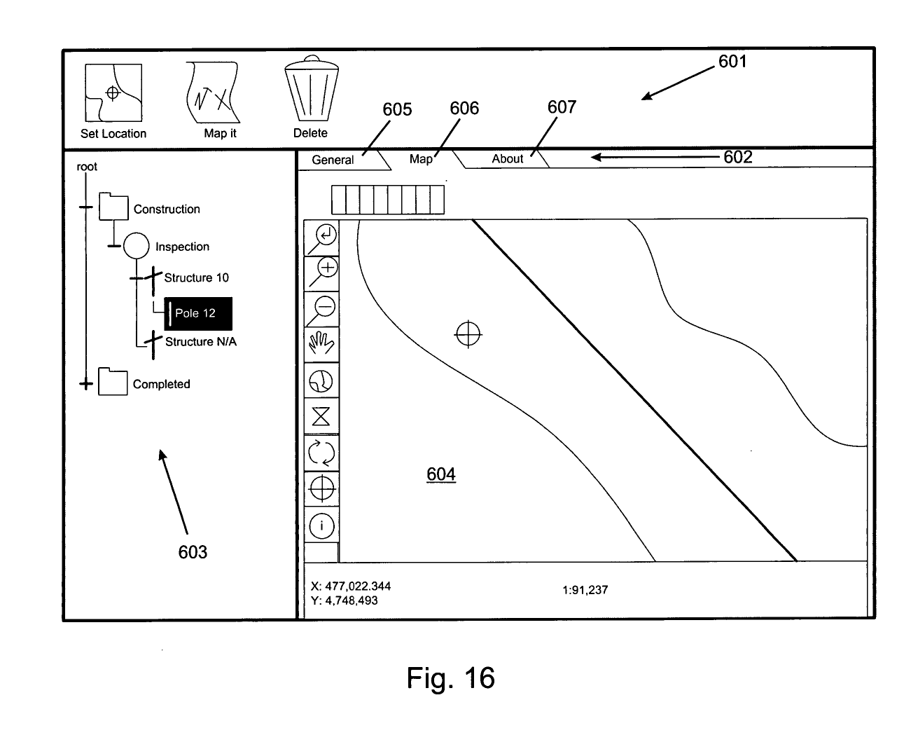

FIG. 16 shows the graphical user interface (GUI) of the application with the Map interface toggled on. The interface is designed with large icons and text in a font that is easy for users to see and understand, particularly field users who may be relatively inexperienced with computers, in all weather and light conditions. This type of screen layout is particularly well-suited to a tablet PC, which has sufficient screen size to display all of the data provided on the interface. The tool bar 601 allows the user to perform actions such as moving work between different states within the work flow, generating reports, synchronizing data, etc. A series of drop-down menus are also provided. Toggle tabs 602 allow the user to toggle between different user interfaces. These interfaces include General 605, Map 606, and About 607. Other interface tabs may also be provided. The tabs allow users to rapidly change the information displayed on the screen depending on their needs. The asset identification tree 603 shows assets in a hierarchical fashion so that the parent object for a given asset is readily identified. For example, the display shows that the pole AZL6MW is part of a structure AZL6MW, which is part of an inspection work request 2005_05_21-21_06_00. The map 604 provides a geo-spatial location of the asset (both for navigation and identification purposes), natural features such as waterways and topography, human features such as roadways, political boundaries, etc. The map 604 also provides users with the ability to pan, zoom and query spatial features. The GPS receiver provides users with a real-time position in relation to the geo-spatial asset locations. While completing a work request, users move work in a downward fashion through the various folders in the tree 603 as defined by the business process. Each folder represents a step in the business process and when the work has been moved to the bottom folder, all business processes required by the user are complete. The vertical database schema makes the MD, WRD, LAAD, LWRD amenable to changes in the forms, without requiring changes to the underlying structure of the databases themselves. Since business processes change frequently, this advantageously provides for the updating of forms during synchronization without extensive changes to the databases or application engine.

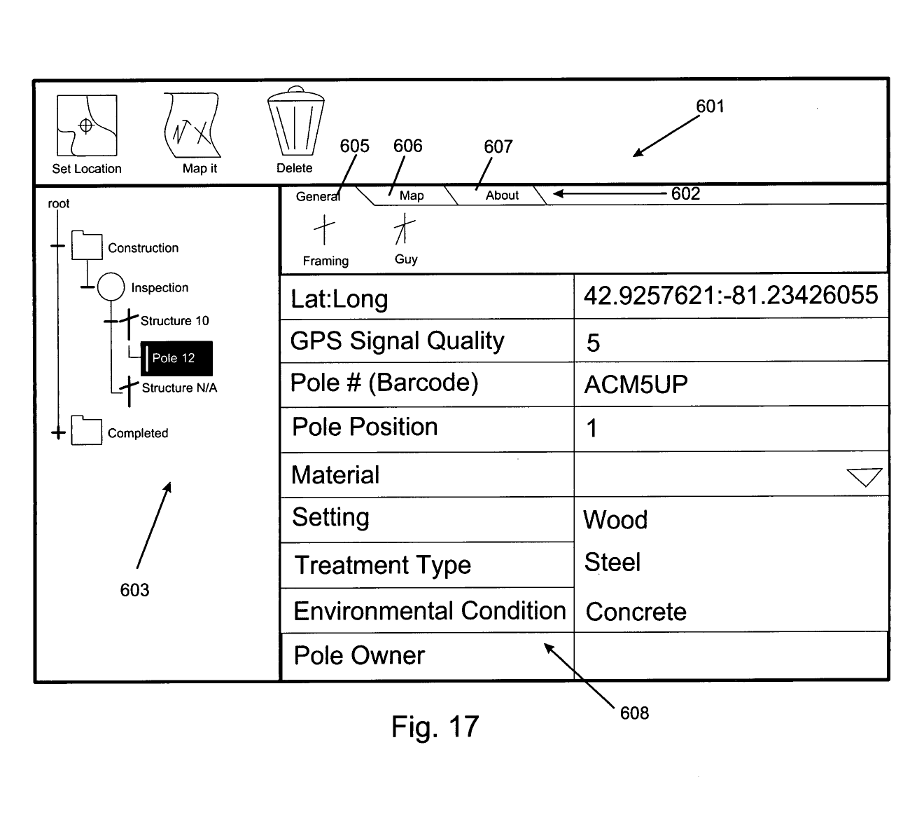

FIG. 17 shows the graphical user interface (GUI) of the application when the General interface 605 is toggled on. The attributes 608 of the asset identified in the work request are provided in the left hand column of the interface. A pen-based input device is used to populate or update the attributes 608 in a data entry field to the right of each attribute. Upon entering data into a data entry field, the LWRD 130 (not shown in FIG. 9) is updated; this immediate live-entry of data without the need for confirmation speeds data entry and prevents inadvertent data loss due to power failure, etc. When all forms related to the asset have been completed and the user has moved downwardly through the tree 603 with each successive form, a confirmation box is displayed asking whether the user wishes to electronically sign off on the work request. If this box is accepted, the work order is closed and a new work order is automatically opened for data collection on a new asset. The LAAD can then be automatically or manually updated with attribute data from the LWRD. If the box is not accepted, then the work order is not closed and the user is permitted to continue entering data on the current asset.

Other advantages which are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A method of collecting geo-spatially referenced data using a mobile computing device having a global positioning satellite (GPS) data receiver, a data storage device, a central processing unit (CPU), a graphical display, and a network connection means, the method comprising:
a) providing a network-accessible asset attribute database (AAD), the AAD containing attribute information relating to a plurality of geo-spatially distributed assets, each asset having a set of GPS co-ordinates;
b) providing a network-accessible work request database (WRD), the WRD containing a plurality of work requests, each work request relating to a geo-spatially distributed asset in the AAD, the WRD including attribute information from the AAD for the asset;
c) receiving work request information from the WRD via the network connection means and creating a local work request database (LWRD) containing the work request information;
d) allowing a mobile user to make changes to the attribute information in the LWRD in fulfilment of the work requests; and,
e) periodically synchronizing the mobile computing device using the network connection means to update the WRD with both the work request and attribute information in the LWRD.

2. The method according to claim 1, wherein both the WRD and the AAD have a vertical database schema.

3. The method according to claim 2, wherein the method further comprises generating a report based on the MD and/or WRD by converting the vertical database schema to a relational database schema.

4. The method according to claim 1, wherein the method further comprises updating a local asset attribute database (LMD) stored on the mobile computing device using attribute information in the LWRD.

5. The method according to claim 4, wherein the LAAD is updated with asset attribute information from the LWRD following completion of each work request.

6. The method according to claim 4, wherein the LAAD is identical in structure to the MD.

7. The method according to claim 1, wherein the LWRD is identical in structure to the WRD.

8. The method according to claim 1, wherein the data from the LWRD is appended to the WRD upon synchronization as newly appended data.

9. The method according to claim 8, wherein, after synchronization, the newly appended data is compared with attribute information in the WRD and any information conflicts are automatically flagged for resolution.

10. The method according to claim 1, wherein the MD is periodically updated with the attribute information in the WRD.

11. The method according to claim 1, wherein each change made by the mobile user to the attribute information is immediately live-entered into the LWRD without requiring user-confirmation of the change.

12. The method according to claim 1, wherein the method further comprises generating a local work request on the mobile computing device and entering the local work request into the LWRD.

13. The method according to claim 1, wherein the MD contains two tables: a first table containing information identifying the asset; and, a second table containing attribute information for the asset including the GPS co-ordinates of the asset.

14. The method according to claim 1, wherein the method further comprises updating one or more data collection forms upon synchronization without changing the WRD or MD.

15. The method according to claim 1, wherein the attribute information for a given geo-spatially distributed asset includes connection information describing connections between the asset and one or more other geo-spatially distributed assets.

16. The method according to claim 1, wherein the mobile computing device is disconnected from the network during data collection.

17. A method of managing geo-spatially referenced data comprising:
a) providing a asset attribute database (MD), the MD containing attribute information relating to a plurality of geo-spatially distributed assets, each asset having a set of GPS co-ordinates;
b) providing a work request database (WRD), the WRD containing a plurality of work requests, each work request relating to a geo-spatially distributed asset in the MD, the WRD including attribute information from the MD for the asset;
c) periodically updating the attribute information in the WRD in fulfillment of the work requests; followed by,
d) periodically updating the attribute information in the MD with the attribute information in the WRD.

18. A method according to claim 17, wherein both the WRD and MD have a vertical database schema.

19. A computer software application for managing geo-spatially referenced data comprising:
a) an asset attribute database (MD), the MD containing attribute information relating to a plurality of geo-spatially distributed assets, each asset having a set of GPS co-ordinates; and,
b) a work request database (WRD), the WRD containing a plurality of work requests, each work request relating to a geo-spatially distributed asset in the MD, the WRD including attribute information from the MD for the asset.

20. A computer software application according to claim 19, wherein both the WRD and MD have a vertical database schema.
